(19) United States
(12) Patent Application Publication
(10) Pub. No.: US 2009/0150446 A1
(43) Pub. Date: Jun. 11, 2009

(54) AUTHENTICITY INVESTIGATION METHODS, DEVICES AND COMPUTER PROGRAM PRODUCTS

(75) Inventors: Juha Lehtola, Raisio (FI); Marko Merenheimo, Fagervik (FI)

Correspondence Address: MYERS BIGEL SIBLEY & SAJOVEC, PO BOX 37428, RALEIGH, NC, 27627, US

(73) Assignee: Trackway OY

(21) Appl. No.: 12/331,749

(22) Filed: Dec. 10, 2008

Related U.S. Application Data
(60) Provisional application No. 61/007,080, filed on Dec. 11, 2007.

(51) Int. Cl. G06F 17/00; G06Q 99/00; G06Q 10/00; G06Q 30/00

(52) U.S. Cl. 707/104.1; 705/1; 705/28; 705/29

(57) ABSTRACT

The invention concerns a method, authentication data handling device and computer program product for investigating a product. The authentication data handling device includes a database comprising product identifiers of authentic products, and a control unit. The control unit receives, from a user, a code of a product which is to be investigated, compares the code with a product identifier stored in a database, indicates the authenticity of the product if the codes match, requests a contacting identifier from the user and in case a contacting identifier is received from the user, stores this contacting identifier associated with the product identifier in the database in order to allow product information to be transmitted to the user.

### RELATED APPLICATION

This application claims the benefit of and priority to U.S. Provisional Patent Application No. 61/007,080, filed Dec. 11, 2007, the disclosure of which is incorporated herein by reference as if set forth in its entirety.

### BACKGROUND

The present invention relates to the investigation of the authenticity of products. The invention more particularly relates to methods, authentication data handling devices and computer program products for investigating a product.

Illegal copying of objects is a big problem for companies, organizations and individuals. Illegal copying involves such things as copying products to be sold and counterfeiting. Counterfeiting is an increasing problem for manufacturers and users. Through counterfeiting, copies of goods appear that resemble the goods of the rightful owners. This can lead to considerable economical losses for the companies that provide products.

Due to this, different methods have evolved to identify a product as being rightfully issued by a certain entity, which may be a company, an organization, a state but also individuals.

Systems are known in the art for enabling information exchange related to products. The products are here identified by a unique code. A system for identifying a code then normally involves the reading of the code, which code is attached to or integrated into the product. Reading of the code can then be performed using a reading device. In order to provide authenticity checks, the code is then compared with a product identifier. If the codes match the authenticity is then verified.

It is also known to store data regarding a product in a product database, where the product includes a number of subitems. Data regarding the subitems can then be obtained by a user in a product database. Such a solution is described in U.S. Patent Application Publication No.:US2004/0162828.

However, there is often a need for being able to provide authentication as well as information concerning an authenticated product to a user at other times than when the user is performing the authentication.

Embodiments of the present invention are, therefore, directed towards solving this and other related problems.

### SUMMARY

It should be appreciated that this Summary is provided to introduce a selection of concepts in a simplified form, the concepts being further described below in the Detailed Description. This Summary is not intended to identify key features or essential features of this disclosure, nor is it intended to limit the scope of the invention.

Embodiments of the present invention enable the provision of information concerning an authenticated product to a user at other times than when the user is performing the authentication. In some embodiments, a method for investigating a product includes: receiving a code of a product which is to be investigated from a user; comparing the code with a stored product identifier; indicating the authenticity of the product in response to determining that the code and the product identifier match; requesting a contacting identifier from the user; and storing a received contacting identifier in order to allow product information to be transmitted to the user. The method may further include receiving product specifying data during the production; packaging and/or shipping the product; storing the product specifying data associated with the product identifier; and providing the user with at least some product specifying data regarding the product.

In some embodiments, a brand owner may be connected to in order to allow the user to be provided with product information. Connecting to a brand owner includes sending the contacting identifier of the user and the product identifier to the brand owner in order to allow the brand owner to send product information to the user. Connecting to a brand owner may also include fetching product information from the brand owner and sending this product information to the user.

Product specifying data may include time data indicating various phases in production, packaging and/or shipping. Product specifying data may include condition data regarding production, transportation and/or packaging. Exemplary condition data may include temperature and humidity data, etc.

In some embodiments, a product includes subunits having their own identities and the product specifying data includes the identities of subunits.

According to other embodiments of the present invention, an authentication data handling device for investigating a product includes a database comprising product identifiers of authentic products, and a control unit. The control unit is configured to: receive, from a user, a code of a product which is to be investigated; compare the code with a product identifier stored in the database; indicate the authenticity of the product in response to determining that the code and product identifier match; request a contacting identifier from the user; and store a received contacting identifier associated with the product identifier in the database in order to allow product information to be transmitted to the user. The database includes product specifying data associated with product identifiers. The product specifying data can be gathered during the production, packaging and/or shipping of the product. The control unit is configured to provide the user with at least some product specifying data regarding the product. In some embodiments, the control unit is configured to connect to a brand owner in order to allow the user to be provided with product information.

According to other embodiments of the present invention, a computer program product for investigating a product is provided. The computer program product includes a computer readable storage medium having encoded thereon instructions that, when executed on an authentication data handling device, cause the authentication data handling device to: compare a product code received from a user with a product identifier stored in a database; indicate the authenticity of the product in response to determining that the code and the product identifier match; request a contacting identifier from the user; and store a received contacting identifier associated with the product identifier in the database in order to allow product information to be transmitted to the user.

Embodiments of the present invention have many advantages. They allow a brand owner to stay connected to consumers and other product end users when a product is sold via channels/distributors. At the same time the user is provided with information about the product origin. The invention also enables the user to register into customer loyalty programs in an easy way when performing authentication.

Other methods, devices, and/or computer program products according to exemplary embodiments will be or become apparent to one with skill in the art upon review of the following drawings and detailed description. It is intended that all such additional methods, devices, and/or computer program products be included within this description, be within the scope of the present invention, and be protected by the accompanying claims.

### BRIEF DESCRIPTION OF THE DRAWINGS

The present invention will now be described in more detail in relation to the enclosed drawings, in which:

FIG. 1 schematically shows an authentication data handling device, according to embodiments of the present invention, communicating with a user device via a network,

FIG. 2 shows a table of how content is organized in a database of the authentication data handling device of FIG. 1,

FIG. 3 shows a flow chart outlining a number of method steps taken in a method for investigating a product, according to embodiments of the present invention, being performed in the authentication data handling device, and

FIG. 4 schematically shows a computer program product in the form of a CD ROM disc comprising computer program code for carrying out a method of the present invention.

### DETAILED DESCRIPTION

In the following description, for purposes of explanation and not limitation, specific details are set forth such as particular architectures, interfaces, techniques, etc. in order to provide a thorough understanding of the present invention. However, it will be apparent to those skilled in the art that the present invention may be practiced in other embodiments that depart from these specific details. In other instances, detailed descriptions of well known devices, circuits, and methods are omitted so as not to obscure the description of the present invention with unnecessary detail. While various modifications and alternative forms of the embodiments described herein may be made, specific embodiments are shown by way of example in the drawings and will herein be described in detail. It should be understood, however, that there is no intent to limit the invention to the particular forms disclosed, but on the contrary, the invention is to cover all modifications, equivalents, and alternatives falling within the spirit and scope of the invention as defined by the claims. Like reference numbers signify like elements throughout the description of the figures.

As used herein, the singular forms “a,” “an,” and “the” are intended to include the plural forms as well, unless expressly stated otherwise. It should be further understood that the terms “comprises” and/or “comprising” when used in this specification are taken to specify the presence of stated features, steps, operations, elements, and/or components, but do not preclude the presence or addition of one or more other features, steps, operations, elements, components, and/or groups thereof. It will be understood that when an element is referred to as being “connected” or “coupled” to another element, it can be directly connected or coupled to the other element or intervening elements may be present. Furthermore, “connected” or “coupled” as used herein may include wirelessly connected or coupled. As used herein, the term “and/or” includes any and all combinations of one or more of the associated listed items and may be abbreviated as “/”.

Unless otherwise defined, all terms (including technical and scientific terms) used herein have the same meaning as commonly understood by one of ordinary skill in the art. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

It will be understood that, although the terms first, second, etc. may be used herein to describe various elements, these elements should not be limited by these terms. These terms are only used to distinguish one element from another.

Exemplary embodiments are described below with reference to block diagrams and/or flowchart illustrations of methods, apparatus (systems and/or devices) and/or computer program products. It is understood that a block of the block diagrams and/or flowchart illustrations, and combinations of blocks in the block diagrams and/or flowchart illustrations, can be implemented by computer program instructions. These computer program instructions may be provided to a processor of a general purpose computer, special purpose computer, and/or other programmable data processing apparatus to produce a machine, such that the instructions, which execute via the processor of the computer and/or other programmable data processing apparatus, create means (functionality) and/or structure for implementing the functions/acts specified in the block diagrams and/or flowchart block or blocks.

These computer program instructions may also be stored in a computer-readable memory that can direct a computer or other programmable data processing apparatus to function in a particular manner, such that the instructions stored in the computer-readable memory produce an article of manufacture including instructions which implement the functions/acts specified in the block diagrams and/or flowchart block or blocks.

The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions/acts specified in the block diagrams and/or flowchart block or blocks.

Accordingly, exemplary embodiments may be implemented in hardware and/or in software (including firmware, resident software, micro-code, etc.). Furthermore, exemplary embodiments may take the form of a computer program product on a computer-usable or computer-readable storage medium having computer-usable or computer-readable program code embodied in the medium for use by or in correction with an instruction execution system. In the context of this document, a computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Computer program code for carrying out operations of data processing systems discussed herein may be written in a high-level programming language, such as Python, Java, AJAX (Asynchronous JavaScript), C, and/or C++, for development convenience. In addition, computer program code for carrying out operations of exemplary embodiments may also be written in other programming languages, such as, but not limited to, interpreted languages. Some modules or routines may be written in assembly language or even micro-code to enhance performance and/or memory usage. However, embodiments are not limited to a particular programming language. It will be further appreciated that the functionality of any or all of the program modules may also be implemented using discrete hardware components, one or more application specific integrated circuits (ASICs), or a programmed digital signal processor or microcontroller.

It should also be noted that in some alternate implementations, the functions/acts noted in the blocks may occur out of the order noted in the flowcharts. For example, two blocks shown in succession may in fact be executed substantially concurrently or the blocks may sometimes be executed in the reverse order, depending upon the functionality/acts involved. Moreover, the functionality of a given block of the flowcharts and/or block diagrams may be separated into multiple blocks and/or the functionality of two or more blocks of the flowcharts and/or block diagrams may be at least partially integrated.

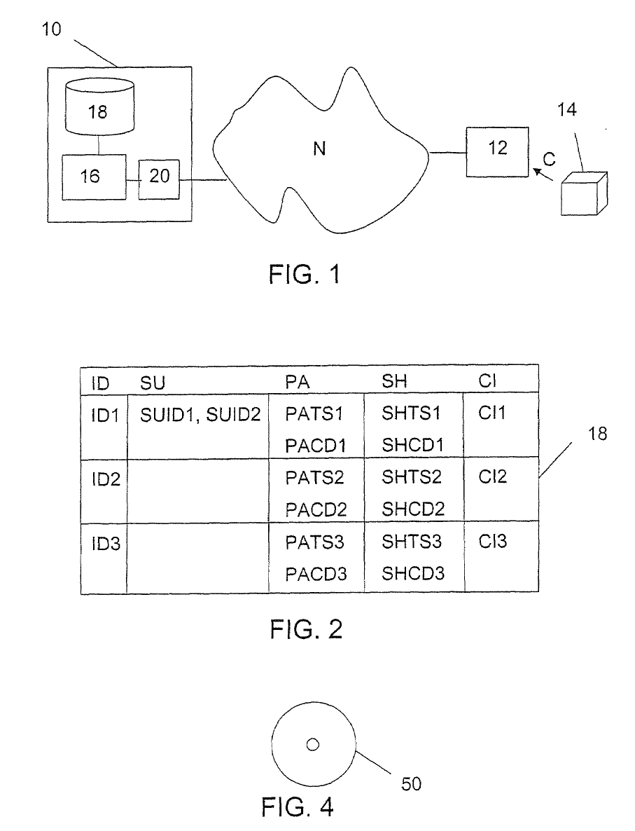

FIG. 1 schematically shows an authentication data handling device 10 according to embodiments of the present invention communicating with a user device 12 via a network N in order to authenticate a product 14. The user device 12 may be a computer or a cellular phone, for example. The user device 12 obtains a code C of the product 14, which it sends to the authentication data handling device 10 via the network N. The network N may be any type of network, such as a LAN, the Internet or some other type of network, like a cellular network such as GSM, GPRS, UMTS or LTE. The authentication data handling device 10 includes a database 18, which includes a table including product identifiers, together with, for each such object product identifier, possible sub identity data, and product specifying data. There is furthermore a database control unit 16 that handles the fetching of data in the database 18 as well as a communication interface 20 for communicating with the network N.

FIG. 2 generally shows how content in the database 18 is organized. The database 18 includes a number of fields. These fields include a product identifier field ID, a subunit identity field SU, a packaging data filed PA, a shipping data filed SH and a contacting identifier data field CI. The packaging data field PA here includes product specifying data related to the packaging, which here includes time data in the form of packaging time stamps PATS and packaging related condition data PACD. The shipping data field SH here includes product specifying data related to the shipping, which here includes time data in the form of shipping time stamps SHTS and shipping related condition data SHCD. The contacting identifier data field CI includes contacting identifiers CI of users of products, which may be e-mail addresses, phone numbers etc. As an example a first product has a first product identifier IDI, two subunit identities SUID1 and SUID2, two items of product specifying data related to the packaging PATS1, PACD1, two items of product specifying data related to the shipping SHTS1, SHCD1 and a contacting identifier CI1 of a user of the product. In a similar manner a second product has a second product identifier 1D2, two items of product specifying data related to the packaging PATS2, PACD2, two items of product specifying data related to the shipping SHTS2, SHCD2 and a contacting identifier CI2 of a user of the product. Finally a third product has a third product identifier 1D3, two items of product specifying data related to the packaging PATS3, PACD3, two items of product specifying data related to the shipping SHTS3, SHCD3 and a contacting identifier C13 of a user of the product.

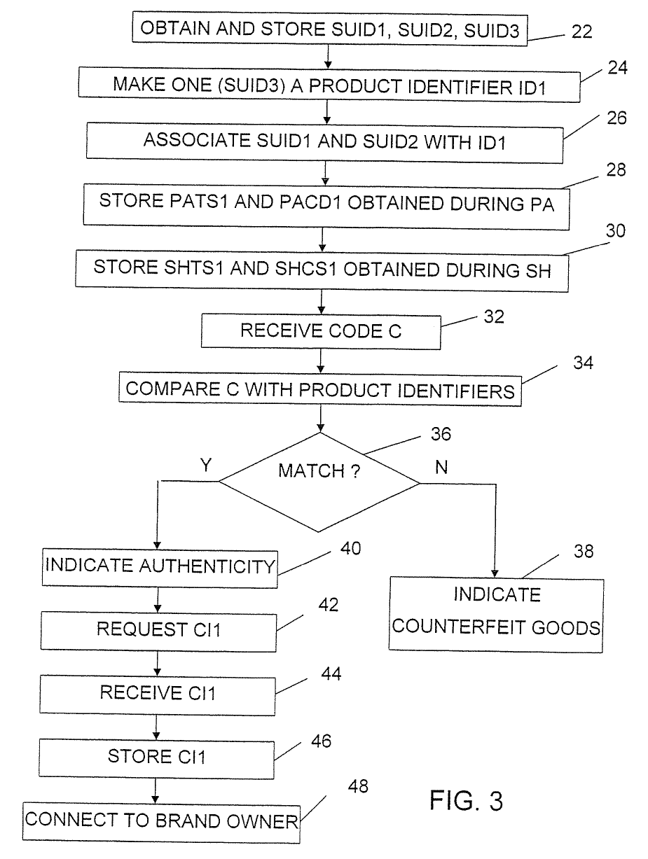

The functioning of the authentication data handling device will now be described for a first product with reference being made to FIGS. 1, 2 and 3, where FIG. 3 shows a flow chart outlining a number of method steps taken in a method for investigating the product, according to embodiments of the present invention, being performed in the authentication data handling device.

As a product is being produced, packaged and shipped to a client, here also named a user, a number of steps are being performed. A product may be made out of a number of subunits. For instance a cellular phone may be packaged with a battery and a charger. In this production these subunits normally have their own identities SUID1, SUID2 and SUID3. In production, the control unit 16 of the authentication data handling device 10 obtains these subunit identities and stores them in the data base 18, step 22. As the product is being packaged one identity is then made into the product identifier ID1, step 24, and here subunit identity SUID3. The other subunit identities SUID1 and SUID2 are then associated with this product identifier ID1, step 26. The third subunit identity SUID3 is thus made into a unique product code ID1. If the product consists of several parts (e.g. battery, charger etc) all parts will have its own unique product code, i.e. subunit identity, and when the product is finally packed to the sales package the codes will be merged into one, the product identifier, which will be used as the product code. In other words after this phase the product code carries information about all the subunits of the product. It should be realized that it is also possible to provide a separate product identity.

The above mentioned identities can be created by using several methods including, but not limited to:
ERP system based serial number
other production system based serial number
LSA fingerprint scanning

As the product is being packaged, the control unit 16 may receive further product specifying data, such as time data in the form of packaging time stamps PATS1, indicating the time of the packaging and packaging related condition data PACD, such as temperature and humidity data for these time stamps. This data is then also stored in the database 18, step 28.

During packaging the product identifier ID I can also be provided on a sales package by using:
RFID tags
other RF-based sensor or storages
bar codes
other type of printed information

The sales package will be placed into a shipping case and further to a pallet. The database records time stamps and creates relevant parent-child relations between units and builds an e-pedigree.

In the same way, the control unit 16 may receive further product specifying data during shipping, such as time data in the form of shipping time stamps SHTS1 indicating various times in the process of shipping the product, and shipping related condition data SHCD1, such as temperature and humidity data for these time stamps. This data is then also stored in the database 18, step 30. Product specifying data may in this manner be recorded through the whole supply chain until the package reaches a client or a user.

Communication with entities involved in the production, packaging and shipping may here be performed via the network N using the communication interface 20.

A user that has purchased the product 14 may then want to enter an authentication session with the authentication data handling device 10 in order to authenticate the product 14. He/she does this through connecting with his/her user device 12 to the authentication data handling device 10 via the network N. The user furthermore obtains a code C of the product 14, for instance provided on the package, and sends it to the authentication data handling device 10. The code C can be sent for instance using SMS, MMS or over the internet (mail, chat-message, browsing a site), etc. The control unit 16 then receives the code C via the communication interface 20, step 32, and compares it with product identifiers in the database 18, step 34. If there is no match, step 36, the product 14 is indicated as being counterfeit goods, step 38, while if there is a match, step 36, then authenticity is indicated, step 40. This indication is then sent to the user device 12 by the control unit 16 via the communication interface 20. In the present example a match was made with the first product identifier ID1 and therefore this is sent to the user device 12.

The control unit 16 may also fetch some or all product specifying data from the database related to the product, such as subunit identities SIID1, SUID2, time stamps and condition data and supply to the user.

During the authentication session the control unit 16 may also ask the consumer to give contact information for further use for sending important messages from the manufacturer to the consumer. The control unit 16 may therefore send a request for a contacting identifier CI1 to the user device 12 via the communication interface 20, step 42. If the user then accepts he/she may send a contacting identifier CII, which is then received by the control unit 16 via the communication interface 20, step 44. The contacting identifier may for instance be a cellular phone number, a chat-ID (MSN, Google, Yahoo, etc.), an email-address, etc. The received contacting identifier CI 1 is then stored in the database 18 associated with the product identifier IDI, step 46. Thereafter the control unit 16 may connect to a device (like a server) of a brand owner, step 48, for instance in order to supply the brand owner with the contacting identifier and the product identifier, perhaps together with product specifying data, in order to allow product information to be transmitted to the user by the brand owner using this contacting identifier. This may be done over the network N via the communication interface 20. When connecting to the brand owner, the control unit 16 may also fetch product information relating to the product and thereafter send it to the user device 12. This sending of product information to the user may be performed in the authentication session.

As an alternative, it is furthermore possible that a contacting identifier is received with the code from the user. In this case it is possible that the user is asked if the contacting identifier may be stored and if the user allows it, it is then stored, otherwise it is deleted. It is here also possible that the control unit 16 fetches product information from the brand owner and supplies to the user. This may be done in both cases, i.e., both when the user accepts storing of the contacting identifier and when the user does not.

In this way, embodiments of the invention allow a brand owner to stay connected to consumers and other product end users when the product is sold via channels/distributors. At the same time the user is provided with information about the product origin. Embodiments of the invention also enable the user to register into customer loyalty programs in an easy way when performing authentication and provides the consumer with relevant and useful product information which comes directly from the manufacturer.

Moreover, embodiments of the invention also help the brand owner to understand which individual consumer that has a certain, individual product, as well as helps in efficient and targeted product recalls.

Embodiments of the present invention may, for instance, be applicable in various industries including, but not limited to:
electronic and technology industry
pharmaceutical and life science industry
media and entertainment
software industry
food industry
luxury goods such as cosmetics, clothing and alcohol

The database 18 may be provided through one or more hard discs. The control unit 16 may be implemented through one or more processors together with computer program code for performing its functions. The program code mentioned above may also be provided as a computer program product, for instance in the form of one or more data carriers carrying computer program code for performing the functionality of the present invention when being loaded into the computer. One such carrier 50, in the form of a CD ROM disc is generally outlined in FIG. 4. It is, however, feasible with other data carriers, like diskettes, memory sticks or USE3 memories. The computer program code can furthermore be provided as pure program code on an external server and fetched from there for provision in the authentication data handling device 10.

There are many possible variations to embodiments of the present invention. The database 18 was above shown as a central database. The invention is not limited to this. It can be decentralized using a number of databases which communicate with each other using a communication protocol, for example the communication protocol presented in WO04051510, which document is herein incorporated by reference. It should furthermore be realized that product specifying data, such as time data and condition data may also be stored in the database 18 during production. The product specifying data may also include location data, for instance data indicating the various geographical locations of production, packaging and shipping. In relation to shipping, such data may be obtained through receiving position data from GPS devices on a container in which the product is shipped.

The user device may in its simplest form be just a tool that a user uses, i.e. the user obtains the code and manually enters it into a message being sent. As an alternative it is possible that the user device 12 includes a code reading unit, for instance a bar code reader or an RFID reader, which reads the code under the control of the control unit for sending to the authentication data handling device 10.

Many variations and modifications can be made to the embodiments without substantially departing from the principles of the present invention. All such variations and modifications are intended to be included herein within the scope of the present invention, as set forth in the following claims.

That which is claimed:

1. A method for investigating a product comprising:
receiving a code of a product which is to be investigated from a user;
comparing the code with a stored product identifier;
indicating the authenticity of the product in response to determining that the code and the product identifier match;
requesting a contacting identifier from the user; and
storing a received contacting identifier in order to allow product information to be transmitted to the user.

2. The method of claim 1, further comprising:
receiving product specifying data during the production;
packaging and/or shipping the product;
storing the product specifying data associated with the product identifier; and
providing the user with at least some product specifying data regarding the product.

3. The method of claim 2, wherein the product specifying data includes time data indicating various phases in production, packaging and/or shipping.

4. The method of claim 2, wherein the product specifying data includes condition data regarding production, transportation and/or packaging.

5. The method of claim 4, wherein the condition data comprises temperature and humidity data.

6. The method of claim 1, wherein the product includes subunits having their own identities and the product specifying data includes the identities of subunits.

7. The method of claim 1, further comprising connecting to a brand owner in order to allow the user to be provided with product information.

8. The method of claim 7, wherein connecting to a brand owner comprises sending the contacting identifier of the user and the product identifier to the brand owner in order to allow the brand owner to send product information to the user.

9. The method of claim 7, wherein connecting to a brand owner comprises fetching product information from the brand owner and sending this product information to the user.

10. An authentication data handling device for investigating a product comprising:
a database comprising product identifiers of authentic products; and
a control unit configured to:
receive, from a user, a code of a product which is to be investigated;
compare the code with a product identifier stored in the database;
indicate the authenticity of the product in response to determining that the code and product identifier match;
request a contacting identifier from the user; and
store a received contacting identifier associated with the product identifier in the database in order to allow product information to be transmitted to the user.

11. The authentication data handling device of claim 10, wherein the database includes product specifying data associated with product identifiers, the product specifying data being gathered during the production, packaging and/or shipping of the product, and wherein the control unit is configured to provide the user with at least some product specifying data regarding the product.

12. The authentication data handling device of claim 10, wherein the control unit is configured to connect to a brand owner in order to allow the user to be provided with product information.

13. A computer program product for investigating a product, comprising a computer readable storage medium having encoded thereon instructions that, when executed on an authentication data handling device, cause the authentication data handling device to:
compare a product code received from a user with a product identifier stored in a database;
indicate the authenticity of the product in response to determining that the code and the product identifier match;
request a contacting identifier from the user; and
store a received contacting identifier associated with the product identifier in the database in order to allow product information to be transmitted to the user.
